(19) United States
(12) Patent Application Publication
(10) Pub. No.: US 2011/0229649 A1
(43) Pub. Date: Sep. 22, 2011

(54) SUPERSONIC MATERIAL FLAME SPRAY METHOD AND APPARATUS

(76) Inventors: Viatcheslav E. Baranovski, Richmond, VA (US); Andrew V. Baranovski, Richmond, VA (US)

(21) Appl. No.: 12/729,213

(22) Filed: Mar. 22, 2010

(51) Int. Cl. B05D 1/08; B05B 1/24

(52) U.S. Cl. 427/446; 239/132.1; 239/135

(57) ABSTRACT

A method of forming a coating deposits a material onto a substrate with high velocity thermal spray apparatus. The method comprises the steps of mixing of an oxidizer gas and a gaseous fuel in the mixing unit, igniting and combusting the oxidizer and gaseous fuel mixture in the combustion chamber, feeding products of combustion to the accelerating nozzle, introducing selected spraying material into accelerating nozzle to form a supersonic stream of hot combustion product gases with entrained particles of spray material, and spraying at high velocity onto a surface positioned in the path of the stream at the discharge end of the nozzle; and forming a non-clogging convergent-divergent gas dynamic virtual nozzle (GDVN) in the accelerating nozzle by annularly introducing a coaxial gas flow, through a narrow continuous slot of circumferential ring geometry in the vicinity of the entrance to the diverging outlet bore of the accelerating nozzle.

### BACKGROUND OF THE INVENTION

This invention relates in general to flame spray apparatus and to methods of deposition of coatings and bulk materials with thermal spray techniques. More specifically, the invention relates to high-velocity oxidizer-fuel spraying apparatus and methods.

Thermal spraying is widely used to apply metals and ceramics in a form of coating or bulk materials on different types of substrates. A majority of thermal spray methods utilize energy of hot gaseous jets to heat and accelerate particles of spraying material. When impinging the substrate, the particles form a coating.

High-Velocity Oxygen-Fuel (HVOF) spraying apparatus and techniques, which use oxygen as an oxidizer gas, or High-Velocity Air-Fuel (HVAF) spraying apparatus and techniques, which use air as an oxidizer gas, generate a jet of hot gases due to combustion of a fuel and oxidizer in an internal burner at elevated pressure, usually several bars. The fuel can be gaseous (e.g., propane, methane, propylene, MAPP gas (i.e., liquefied petroleum gas (LPG) mixed with methylacetylene-propadiene), hydrogen, etc.) or liquefied fuel (e.g., kerosene). From the burner, the gas expands into an exhaust nozzle, reaching sonic velocity if the nozzle is straight. If the nozzle is convergent-divergent, further expansion into wider section of the nozzle results in formation of a supersonic velocity jet. This allows entrained particles of sprayed material to reach higher velocities and form coatings with better mechanical properties, compared to those achieved with straight nozzles.

In spite of the technological advantages of higher particle velocities generated by supersonic convergent-divergent nozzles, there are some disadvantages caused by gaseous flow temperature drop in the divergent portion of the nozzle due to gas expansion. For typical industrial HVOF torches, where combustion chamber temperature typically reaches about 2600° C., the exit gas temperature is only about 1900° C. at stagnation pressures 7-8 bar. So, lowered heating capacity of a supersonic gas flow further reduces particle temperature that, in turn, leads to lower deposition efficiency (DE) of sprayed material, compromises coating quality, and applies limitations for spraying materials with high melting points. This cooling effect of expanded gas flow is even more detrimental for HVAF torches, since maximal temperature of combustion of air-fuel mixture in a combustion chamber is only about 1900° C., and exit gas temperature is about 1200° C. for typical stagnation pressure 6-7 bar, e.g. Mach numbers around 2. This temperature is lower than melting points of most commercial hard facing alloys and cermets, such as the most popular tungsten carbide (WC) based and chrome carbide (Cr₃C₂) based composite powders. So, the use of convergent-divergent nozzles with HVAF torches significantly compromises coating quality and lowers DE of such materials due to lack of heat, in spite of higher particle velocities achievable with supersonic nozzles. For this reason supersonic nozzles have not found use for HVAF torches so far.

Another disadvantage of a convergent-divergent nozzle is the difficulty of powder injection. For example, the powder cannot be fed axially through the combustion chamber, since being heated and partially melted in the burner it would plug the nozzle at the throat, where the cross sectional area is minimal and powder particles come in physical contact with nozzle bore walls. Though clogging can be prevented by significant increase of nozzle bore diameter, this would simultaneously increase flows of both oxidizer and fuel, which reduces economical effectiveness of the process. So, in practice, the radial powder injection into divergent part of the nozzle is usually used. However, this type of powder injection also causes problems, such as lack of heat available for particle heating in the divergent portion of a nozzle, and nozzle clogging caused by radially injected powder.

Advancement in the HVAF apparatus and technique included a secondary fuel flow, which is added to an oxidizing flame jet in the divergent part of a nozzle such that any free oxygen within the flame jet is consumed by the secondary fuel to increase the static temperature of the jet in the divergent part of the nozzle. In order to combust effectively in the relatively cold supersonic jet, where fuel contact time with oxygen is too short, a very reactive secondary fuel of high flame temperature is used. The secondary fuel may be selected from the class consisting of acetylene, methylacetylene and its compounds, and hydrogen.

Disadvantage of said technique and apparatus is the complexity of the process due to the need in highly reactive high flame temperature secondary fuel, different from primary fuel. At the same time there is still a problem with injection of powder axially due to the plugging of the nozzle throat.

### SUMMARY OF THE INVENTION

The present invention is related to a method of forming a coating by depositing a material onto a substrate with high-velocity thermal spray apparatus, wherein the apparatus comprises a mixing unit, a combustion chamber, and a non-clogging supersonic accelerating nozzle. The method comprises the steps of mixing of an oxidizer gas and a gaseous fuel in the mixing unit, igniting and combusting the oxidizer and gaseous fuel mixture in the combustion chamber, feeding products of combustion to the accelerating nozzle, introducing selected spraying material into accelerating nozzle to form a supersonic stream of hot combustion product gases with entrained particles of spray material, and spraying at high velocity onto a surface positioned in the path of the stream at the discharge end of the nozzle. The method further includes a step of forming a non-clogging convergent-divergent gas dynamic virtual nozzle (GDVN) in the accelerating nozzle by annularly introducing a coaxial gas flow, through a narrow continuous slot of circumferential ring geometry in the vicinity of the entrance to the diverging outlet bore of the accelerating nozzle. Thus, the hot combustion product gases discharged from a combustion chamber are compressed in diameter through gas dynamic forces exerted by a coaxially co-flowing gas, obviating the need for a solid nozzle to form a convergent-divergent flow and thereby alleviating the clogging problems that plague conventional solid nozzle, especially in its minimal diameter that creates choked flow condition needed to form a supersonic gas flow in the divergent part of the nozzle. Of particular advantage is the use of compressed air or air-fuel mixture for creating a coaxial gas flow.

### BRIEF DESCRIPTION OF THE DRAWINGS

FIG. 1 is a preferred embodiment of the invention that is a longitudinal sectional view of an internal burner of HVAF apparatus or device used to project with supersonic velocity a flow of fusible particles to build up a coating of such heat-softened and molten particles on a surface downstream of the discharge end of the apparatus illustrated.

FIG. 2 is the preferred embodiment, showing an enlarged, sectional view of a throat portion of the supersonic GDVN of the apparatus of FIG. 1 illustrating the nature of forming a supersonic GDVN by annularly introducing a coaxial gas flow through a narrow continuous slot of circumferential ring geometry.

FIG. 3 is another embodiment, showing an enlarged, sectional view of a throat portion of the supersonic GDVN of the apparatus of FIG. 1 illustrating the nature of forming a supersonic GDVN by annularly introducing a coaxial gas flow through a circular series of closely spaced nozzle orifices.

FIG. 4 is yet another embodiment, showing an enlarged, sectional view of a throat portion of the supersonic GDVN of the apparatus of FIG. 1 illustrating the nature of forming a supersonic GDVN by annularly introducing a coaxial gas flow through a permeable portion of the nozzle wall of circumferential ring geometry.

### DESCRIPTION OF THE PREFERRED EMBODIMENT

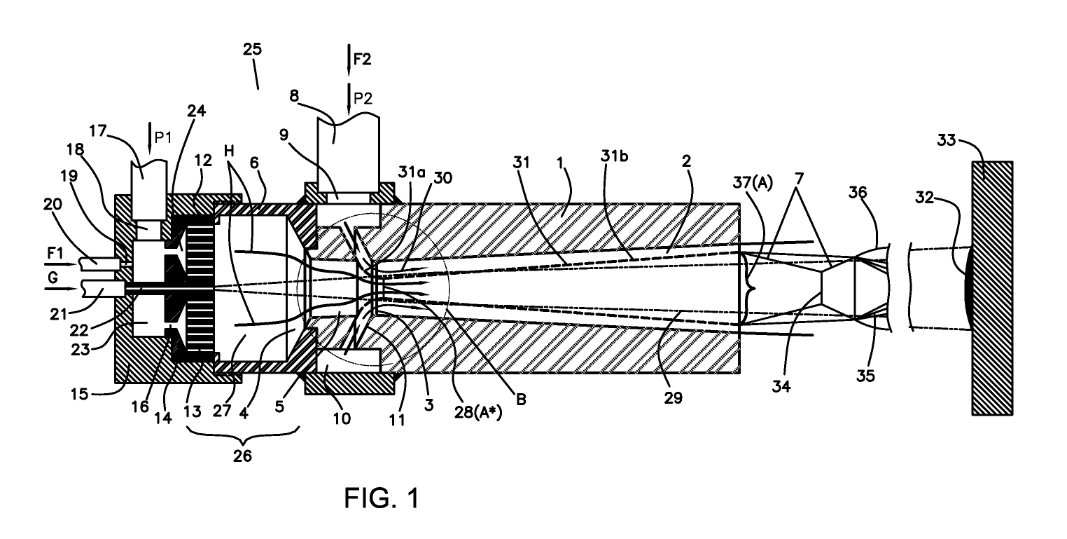

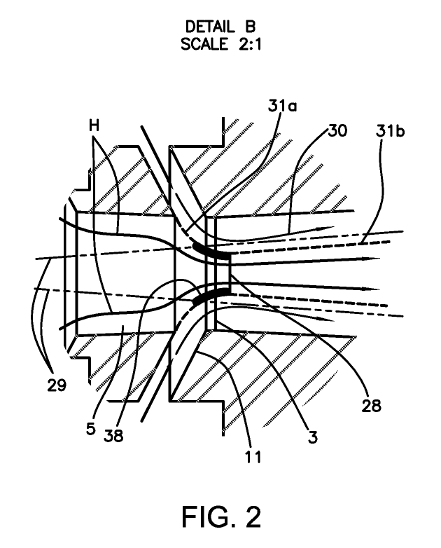

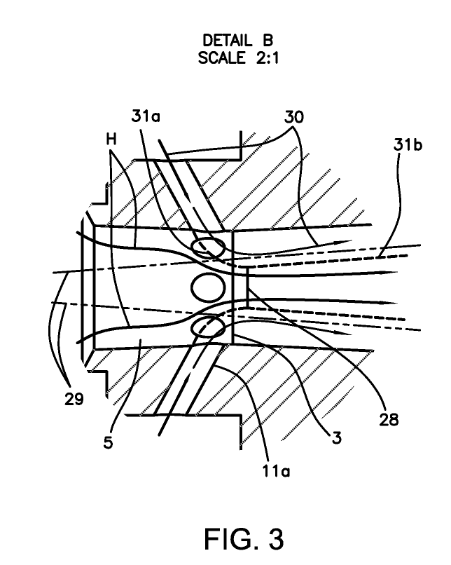

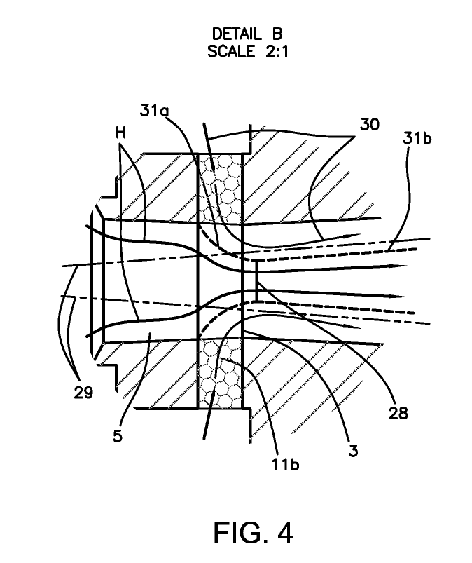

Referring to the drawing, a better understanding of the principles of this invention may be gauged by inspection of FIG. 1. In FIG. 1 an improved internal burner type supersonic velocity flame jet apparatus indicated generally at 25 takes the form of an internal burner 26 comprised of cylindrical section 6, which is closed off at its upstream end by a permeable burner block 12 and closed off at its downstream end by an exit accelerating nozzle piece 1, thus forming a combustion chamber 27 internally of burner 26. The accelerating nozzle piece 1 is provided with an axial nozzle bore, comprising an inlet bore 5 followed by an outlet diverging bore 2 that opens downstream. The radial dimension of an inlet bore 5 should be big enough in order to prevent heated powder stream 29 from touching the walls of the inlet bore 5. The inlet bore 5, which can be converging as shown in FIG. 1, diverging (not shown), or straight (not shown), or be of variable geometry (not shown), of the accelerating nozzle piece 1 is connected to the combustion chamber 27 by a converging inlet passage 4. The rear piece 15 is provided with holes 18 and 19, which open to the interior of the mixing chamber 23, and which receive respectively the ends of primary oxidizer supply tube 17 and primary fuel supply tube 20. A combustible mixture distributor 14 has a circular series of orifices 16, which connect a mixing chamber 23 with circular shape distribution chamber 24. A permeable burner block 12 typically made of high temperature ceramic has a plurality of small diameter orifices 13, which open into the combustion chamber 27. An orifice of axial powder injector 22 opens to the interior of the combustion chamber 27, and receives the end of powder supply tube 21. A narrow continuous slot 11 of a circumferential ring geometry shown in FIG. 2, or alternatively a circular series of closely spaced orifices 11a shown in FIG. 3, or alternatively a permeable portion of the nozzle wall 11b of a circumferential ring geometry shown in FIG. 4 open to the interior of the accelerating nozzle 1 in the vicinity of the entrance 3 to the diverging outlet bore of the accelerating nozzle 1, and to the interior of a circular cavity 10. The accelerating nozzle piece 1 is provided with a hole 9 which opens to the interior of the circular cavity 10, and which receives the end of secondary gas supply tube 8.

Thus, reactants including a fuel as indicated by arrow F1 and an oxidizer as indicated by arrow P1 are fed into the mixing chamber 23 where they form a combustible mixture, which is fed through the orifices 16 into the distribution chamber 24 and further, through the plurality of orifices 13 in the permeable burner block 12, into the combustion chamber 27 with ignition and combustion taking place within the chamber 27 and hot combustion product gases pass through the accelerating nozzle piece 1. The ignition means is not shown, but it is usually a regular spark plug placed in the combustion chamber. High melting point particles indicated schematically by arrow G may be introduced axially into burning gases within combustion chamber 27 through the tube 21 and powder injector 22 and further accelerated in the supersonic GDVN 31 formed within the bore of accelerating nozzle piece 1. A heated powder stream 29 forms a coating 32 upon impact against a substrate 33.

In one aspect the present invention is directed to a method and apparatus for eliminating clogging of the throat of a supersonic nozzle by utilizing GDVN instead of actual solid convergent-divergent nozzle. A coaxial gas flow as indicated by arrow P2 is fed into the circular cavity 10 through the secondary gas supply tube 8 and orifice 9. A supersonic GDVN 31 is defined as an inner boundary of a coaxially co-flowing gas 30 through a narrow continuous slot of circumferential ring geometry 11 under pressure that is higher than the static pressure in the main flow of hot combustion product gases H. Formed this way GDVN 31 has a supersonic convergent-divergent shape having convergent 31a and divergent 31b portions, with a virtual throat 28 having flow area at sonic point A*, and exit 37 having exit flow area A. The ratio A/A* is determined by Mach number at which the spray torch is supposed to operate, and can be adjusted by changing the flow rate of a coaxial gas flow 30 forming GDVN. Thus, the main high velocity stream of hot combustion product gases, as indicated by arrows H, discharged from the combustion chamber 27 and flowing through the inlet bore 5 is further compressed in diameter through gas dynamic forces exerted by gas 30 coaxially co-flowing through a narrow continuous slot of circumferential ring geometry 11 and forming convergent portion 31a of GDVN 31. The main high velocity hot gas stream H with entrained powder particles is further accelerated to supersonic velocity in the divergent portion 31b of GDVN 31 forming a supersonic flame jet indicated generally at 36, characterized by oblique shock waves 7, Mach disks 34, and expansion fans 35. Therefore, a supersonic GDVN 31 obviates the need for a solid nozzle to form a convergent-divergent flow and at the same time alleviates a possible build-up 38, as shown in FIG. 2, which would plague conventional solid nozzle of thermal spray apparatus, if it had the same throat diameter as GDVN throat 28. Since virtual throat 28's cross sectional area A*, which actually forms a choke condition for the stream of hot combustion product gases H, is intentionally designed to be much smaller than any cross sectional area of the accelerating nozzle piece 1, including entrance 3 to the diverging outlet bore of the solid accelerating nozzle piece 1, the inlet bore 5 may have any shape, since it does not affect operation of the GDVN, e.g. it can be straight cylindrical, or diverging, or be of variable geometry, if desired or otherwise necessary. While any gas may be used for forming a coaxial gas flow that forms a supersonic GDVN, of particular advantage is the use of compressed air, which allows for significant reduction of cost of coating application.

In another aspect the present invention is directed to a method and apparatus for increasing the jet temperature by adding a reactive fuel to the gases in the coaxial gas flow 30 forming a supersonic GDVN 31. The secondary fuel as indicated by arrow F2 may be pre-mixed with air, oxygen or other gas forming a coaxial gas flow 30 and a supersonic GDVN 31, and fed through tube 8 and hole 9. Alternatively, the secondary fuel may be fed at least through one additional circular series of orifices (not shown), or narrow continuous slot of circumferential ring geometry (not shown), or a permeable portion of the nozzle wall of circumferential ring geometry (not shown), located in the vicinity of the narrow continuous slot of circumferential ring geometry 11. The secondary fuel may be low reactive gaseous fuel, selected from the group consisting of propane, propylene, methane, ethane, butane, or liquid fuel which may in the form of mist, vapor, or liquid. The secondary fuel is pre-heated by the stream of hot combustion product gases discharged from the combustion chamber 27, reaching auto ignition temperature, and burns in the divergent portion of the coaxial gas flow 30 that forms a supersonic GDVN 31. This burning gas expands inwards the core of the stream of hot combustion product gases, which is supersonic due to expansion in a supersonic GDVN 31, until essentially complete mixing takes place. Therefore, the combustion of the secondary fuel increases the static temperature of a supersonic flow, which in turn increases velocity of main stream of hot combustion product gases, as well as temperature and velocity of entrained particles. Greater particle velocity and temperature are of extreme importance for low combustion temperature HVAF thermal spray process, and allow to significantly improve coating quality. When even higher particle temperature is needed, the secondary fuel may be a highly reactive gaseous fuel, selected from the group consisting of methyl-acetylene and its compounds, and hydrogen.

In accordance with an exemplary embodiment, a coating is sprayed with an HVAF apparatus 25 comprising an accelerating nozzle piece 1 with means of forming a supersonic GDVN 31 (as described with reference to the FIG. 1). The apparatus 25 is operated with primary air flow of about 55 liters per second, an inlet pressure of about 6.2 bar, and a primary propane flow of about 2.0 liters per second under the pressure of about 5.1 bar. The coaxial air flow 30, forming a supersonic GDVN 31, is about 32 liters per second, at an inlet pressure of about 6.8 bar, and a secondary propane flow is about 1.6 liters per second, at an inlet pressure of about 5.5 bar. Thus, the total heat energy generated by apparatus is about 1,140,000 Btu/hr. A coating is applied using 5-30 μm particle size tungsten carbide-cobalt-chrome 86% WC-10% Co-4% Cr agglomerated-sintered powder. The mean hardness of the coating is measured at about 1,390 HV300. Under these operating parameters, the apparatus is able to operate for a long time without nozzle plugging, generating a very narrow and focused powder stream. The particle velocity of about 1,198 m/sec and particle temperature of about 1,750° C. have been measured with AccuraSpray sensor by Tecnar Automation Ltée (Canada).

Alternatively, for comparison, a regular HVAF apparatus, without supersonic GDVN, but instead having regular straight accelerating nozzle of the same length, and diameter similar to the diameter of the throat 3 of the apparatus with supersonic GDVN, was used to apply a coating with the same material: 5-30 μm particle size tungsten carbide-cobalt-chrome 86% WC-10% Co-4% Cr agglomerated-sintered powder. The apparatus operates with air flow of about 85 liters per second, an inlet pressure of about 6.3 bar, and propane flow of about 3.4 liters per second under a pressure of about 5.3 bar, thus generating 1,050,00 Btu/hr, e.g. the same total amount of heat energy as apparatus with supersonic GDVN according to the exemplary embodiment. The mean coating hardness is measured at about 1,040 HV300. The particle velocity of about 664 msec and particle temperature of about 1,690° C. have been measured with AccuraSpray sensor.

Thus, the use of supersonic GDVN combined with feeding of secondary fuel to the coaxial gas flow forming supersonic GDVN, provides non-clogging operation of HVAF or HVOF apparatus, and when compared to typical HVAF apparatus with a straight cylindrical nozzle, allows for a nearly 2 fold increase in the particle velocity without lowering particle temperature, which significantly improves coating properties.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. In a flame spray method comprising the steps of:
a) Continuously combusting, under pressure, a continuous flow of a fuel-oxidizer mixture confined within an essentially closed internal burner combustion chamber, and
b) Discharging the hot combustion product gases from the combustion chamber through an accelerating nozzle having an inlet bore portion, which may be converging, straight, diverging, or be of variable geometry, and a diverging outlet bore, and
c) Forming a non-clogging convergent-divergent gas dynamic virtual nozzle in the accelerating nozzle by annularly introducing a coaxial gas flow, through a narrow continuous slot of circumferential ring geometry in the vicinity of the entrance to the diverging outlet bore of the accelerating nozzle, thus constricting in diameter the flow of hot combustion product gases and forming a choked flow condition, and then expanding said flow of hot combustion product gases in the diverging outlet bore of the accelerating nozzle, thereby forming a supersonic hot gas stream, and
d) Feeding material to said supersonic stream for high temperature heat softening or liquefaction and spraying at high velocity onto a surface positioned in the path of the stream at the discharge end of the nozzle,

2. A flame spray method as claimed in claim 1, wherein said coaxial gas flow is introduced through a circular series of closely spaced nozzle orifices, or a permeable portion of the nozzle wall of circumferential ring geometry, or a circular series of orifices of variable geometry, or a plurality or combination of said elements.

3. A flame spray method as claimed in claim 1 or claim 2, wherein the annularly introduced coaxial gas flow is at least in part a flow of oxidizer.

4. A flame spray method as claimed in claim 1 or claim 2, wherein the annularly introduced coaxial gas flow is at least in part a flow of compressed air.

5. A flame spray method as claimed in claim 3 or claim 4, wherein the step of introduction of a coaxial gas flow includes feeding of a secondary low reactive gaseous fuel into said coaxial gas flow.

6. A flame spray method as claimed in claim 5, wherein the step of feeding of a secondary low reactive fuel comprises the feeding of gaseous fuel selected from the group consisting of propane, propylene, methane, ethane, butane to said coaxial gas flow.

7. A flame spray method as claimed in claim 3 or claim 4, wherein the step of introduction of coaxial gas flow includes feeding of a secondary high reactive gaseous fuel into said coaxial gas flow.

8. A flame spray method as claimed in claim 7, wherein the step of feeding of a secondary high reactive gaseous fuel comprises the feeding of gaseous fuel selected from the group consisting of methyl-acetylene and its compounds, and hydrogen to said coaxial gas flow.

9. A flame spray method as claimed in claim 3 or claim 4, wherein the step of introduction of coaxial gas flow includes feeding of a secondary liquid fuel in the form of mist, vapor or liquid to said coaxial gas flow.

10. A flame spray method as claimed in claim 9, wherein the step of feeding of a secondary liquid fuel comprises the feeding of kerosene in the form of mist, vapor or liquid to said coaxial gas flow.

11. A flame spray method as claimed in claim 1 or claim 2, wherein the annularly introduced coaxial gas flow is at least in part a flow of a mixture of fuels of high and low reactivity.

12. A flame spray method as claimed in claim 1 or claim 2, wherein the annularly introduced coaxial gas flow is at least in part a flow of a mixture of gaseous and liquid fuels.

13. A supersonic material flame spray apparatus comprising:
a) a spray gun body,
b) a high pressure essentially closed combustion chamber within that body,
c) means for continuously flowing under high pressure an oxidizer-fuel mixture through this combustion chamber for ignition within said chamber,
d) said body further comprising an elongated accelerating nozzle, having combustion products discharging bore, downstream of said combustion chamber, said accelerating nozzle having an inlet bore portion, which may be converging, straight, diverging, or be of variable geometry, and a diverging outlet bore, and,
e) said elongated accelerating nozzle having a narrow continuous slot of circumferential ring geometry in the vicinity of the entrance to the diverging outlet bore of the accelerating nozzle, and means for introducing a continuously flowing coaxial gas flow under high pressure through said narrow continuous slot, for forming a virtual supersonic gas-dynamic nozzle with choked flow condition for accelerating hot combustion product gases discharged from the combustion chamber and carrying particles of spray material, said virtual nozzle preventing physical contact and therefore build-up of particle material on the nozzle bore wall while ensuring supersonic particle velocities prior to particle impact on a substrate downstream of the discharge end of the nozzle bore,
f) said spray gun body comprising means for introducing material in solid form outside of the combustion chamber axially into the hot combustion gases for subsequent heat softening or liquefaction and acceleration in said virtual gas-dynamic nozzle.

14. A flame spray apparatus as claimed in claim 13, wherein said narrow continuous slot of circumferential ring geometry is substituted with a circular series of closely spaced nozzle orifices, or a permeable portion of the nozzle wall of circumferential ring geometry, or a circular series of orifices of variable geometry, or a plurality or combination of said elements.
